(19) United States
(12) Patent Application Publication
(10) Pub. No.: US 2010/0077335 A1
(43) Pub. Date: Mar. 25, 2010

(54) METHOD FOR TRANSFERRING A FILE THROUGH A KM DEVICE BETWEEN ASSOCIATED COMPUTERS

(75) Inventor: Ching-Wei Cheng, Keelung (TW)

Correspondence Address: ROGER H. CHU, 19499 ERIC DRIVE, SARATOGA, CA, 95070, US

(73) Assignee: ACTION STAR ENTERPRISE CO., LTD., Sijhih (TW)

(21) Appl. No.: 12/557,786

(22) Filed: Sep. 11, 2009

Related U.S. Application Data
(60) Provisional application No. 61/099,273, filed on Sep. 23, 2008.

(51) Int. Cl. G06F 13/00; G06F 3/048

(52) U.S. Cl. 715/769; 710/316; 715/856

(57) ABSTRACT

A method for transferring a file through a KM device between associated computers and the method comprises the step of: (a) coupling a first computer host connected with a first monitor, a second computer host connected with a second monitor, a keyboard and a pointing device to a KM device; (b) initializing a pointer controlled by the pointing device on the first monitor; and (c) moving a file displayed on the first monitor to the second monitor by the pointer controlled by the pointing device for transferring the file from the first computer host to the second computer host through the KM device.

### CROSS REFERENCE TO RELATED APPLICATIONS

This application claims priority from a co-pending U.S. Provisional Patent Application Ser. No. 61/099,273 filed Sep. 23, 2008, the entire content of which is incorporated herein by reference.

### BACKGROUND OF THE INVENTION

1. Field of the Invention

The present invention generally relates to a method for transferring a file between a plurality of computers, more particularly to a method which for transferring a file through a KM device between associated computers.

2. Description of the Prior Art

There exist devices for interconnecting a single computer to multiple computers. For example, a keyboard/video/mouse (KVM) switch is a device that is generally connected to multiple computers in order to enable a single keyboard, video monitor and mouse to control each of the connected computers. In this way, a user may have access to multiple computers without having to invest in corresponding keyboards, monitors, and mice for each of the computers. When the user accesses a computer connected to the KVM switch, video signals are routed from the computer, processed, and displayed on the single video monitor. Moreover, a keyboard/mouse (KM) switch is also providing a user accessing multiple computers without having to invest in corresponding keyboards and mice for each of the computers and video signals are routed from the computer, processed, and displayed on associated video monitors.

If the user wants to transfer a file from a first computer to a second computer which both connected to the KM switch, the user has following ways to do so:
1. The user has to transfer the file to internet (for example, an internet mail box) form the first computer, and then downloads the file from internet by the second computer.
2. The user has to prepare a storage device (for example, an USB storage device or a floppy disk) for copying the file from the first computer into the storage device, and then connects the storage device to the second computer for transferring the file in the storage device to the second computer.
3. The user has to prepare a cable for connecting the first and second computer to be an intranet system, and then the user can transfer the file from the first computer to the second computer directly.

However, the above ways for transferring files from one computer to another are not convenient for use. Therefore, it is desirable to provide a way for transferring files from one computer to another through the associated KM switch without complex or multiple steps.

### SUMMARY OF THE INVENTION

The primary objective of the present invention is to provide a method for transferring a file through a KM device between associated computers and the method comprises the step of: (a) coupling a first computer host connected with a first monitor, a second computer host connected with a second monitor, a keyboard and a pointing device to a KM device; (b) initializing a pointer controlled by the pointing device on the first monitor; and (c) moving a file displayed on the first monitor to the second monitor by the pointer controlled by the pointing device for transferring the file from the first computer host to the second computer host through the KM device.

The second objective of the present invention is to provide a method for transferring a file through a KM device between associated computers and the method comprises the step of: (d) coupling a first computer host connected with a first monitor, a second computer host connected with a second monitor, a keyboard and a pointing device to a KM device; (e) initializing a pointer controlled by the pointing device on the first monitor; (f) copy a file displayed on the first monitor; (g) moving the pointer from the first monitor to the second monitor by the pointing device; and (h) paste the file on the second monitor through the KM device.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a flow chart of the method for transferring a file through a KM device between associated computers of the present invention.

FIG. 2 illustrates a further flow chart of the method for transferring a file through a KM device between associated computers of the present invention.

FIG. 3 illustrates another flow chart of the method for transferring a file through a KM device between associated computers of the present invention.

### DETAILED DESCRIPTION OF THE INVENTION

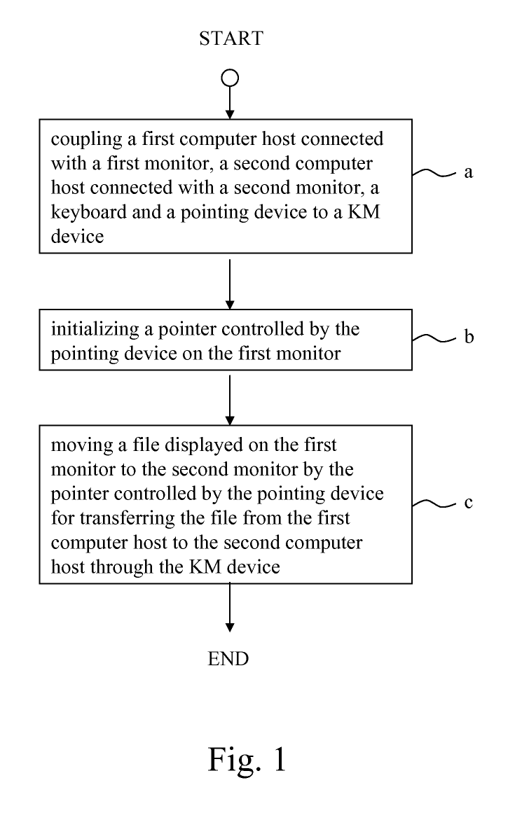

With reference to FIG. 1, which illustrates a flow chart of the method for transferring a file through a KM device between associated computers. When a user want to transfer a file from a first computer host to a second computer host, at first, the user should couple a first computer host connected with a first monitor, a second computer host connected with a second monitor, a keyboard and a pointing device to a KM device (step a) for interconnecting the first computer host and the second computer host through the KM device. When the first computer host and the second computer host are booted, operation systems of the first computer host and the second computer host will initialize a pointer controlled by the pointing device on the first monitor (step b). Operation systems of the first computer host and the second computer host may initialize a pointer controlled by the pointing device on the second monitor. The initialization of the pointer is preset by the KM device. The KM device acquires boundaries of the first monitor and the second monitor (step b1). If the pointer is moved out of the boundary of the first computer host, then the pointer will be displayed on the second computer host. Also, the second computer host is now controlled by the pointing device and the keyboard through the KM device. Similarly, if the pointer is moved out of the boundary of the second computer host, then the pointer will be displayed on the first computer host. Finally, the user moves a file displayed on the first monitor to the second monitor by the pointer controlled by the pointing device for transferring the file from the first computer host to the second computer host through the KM device (step c).

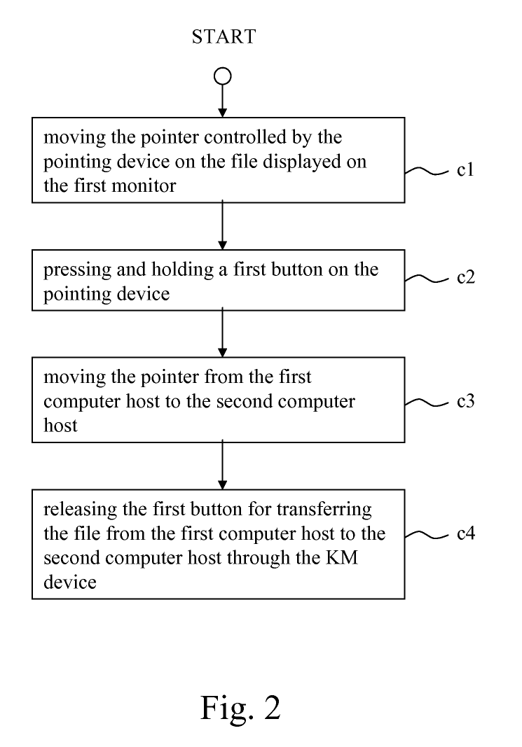

Referring to FIG. 2, in step (c), if the user wants to moves the file displayed on the first monitor to the second monitor, the user should move the pointer controlled by the pointing device on the file displayed on the first monitor (step c1) at first, then press and hold a first button on the pointing device (step c2) and move the pointer from the first computer host to the second computer host (step c3). Now, the pointer is moved from the first monitor to the second monitor and the first button on the pointing device is still pressed and held. The user then releases the first button for transferring the file from the first computer host to the second computer host through the KM device (step c4).

In step (c3), if the pointer moves out the boundary of the first monitor, then the pointer should be moved to the second monitor. The boundaries of the first monitor and the second monitor are acquired by the KM switch after the first computer host and the second computer booted.

Further, if there are three or more computers with associated monitors connected to the KM switch, the KM switch also acquires boundaries of each monitor associated to the computer hosts connected to the KM. The user can transfer a file from one computer host to others by controlling the pointer.

Moreover, the step (c2) can be pressing a second button on the pointing device and the step (c4) can be pressing the second button again for transferring the file from the first computer host to the second computer host through the KM device. Different to the first button on the pointing device, the second button can be defined with copy/paste functions. For example, the second button is pressed when the pointer displayed on a file on the first monitor, the function of the second button is to copy the file. The second button is pressed when the pointer displayed on an empty place of the second monitor, the function of the second button is to paste the file.

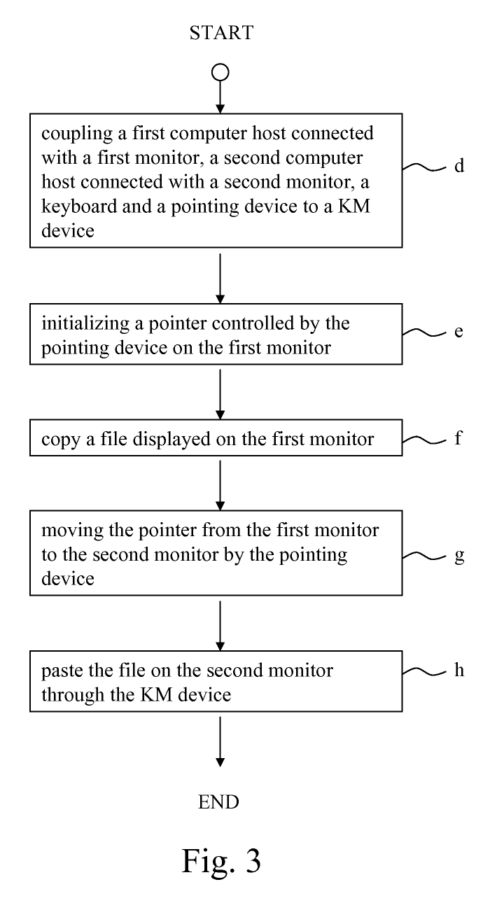

With reference to FIG. 3, which illustrates another flow chart of the method for transferring a file through a KM device between associated computers. When a user want to transfer a file from a first computer host to a second computer host, at first, the user should couple a first computer host connected with a first monitor, a second computer host connected with a second monitor, a keyboard and a pointing device to a KM device (step d) for interconnecting the first computer host and the second computer host through the KM device. When the first computer host and the second computer host are booted, operation systems of the first computer host and the second computer host will initialize a pointer controlled by the pointing device on the first monitor (step e). Operation systems of the first computer host and the second computer host may initialize a pointer controlled by the pointing device on the second monitor. The initialization of the pointer is preset by the KM device. The KM device acquires boundaries of the first monitor and the second monitor. If the pointer is moved out of the boundary of the first computer host, then the pointer will be displayed on the second computer host. Also, the second computer host is now controlled by the pointing device and the keyboard through the KM device. Similarly, if the pointer is moved out of the boundary of the second computer host, then the pointer will be displayed on the first computer host. The user copies a file displayed on the first monitor (step f) and moves the pointer from the first monitor to the second monitor by the pointing device (step g). Finally, paste the file on the second monitor through the KM device (step h) for transferring the file from the first computer host to the second computer host through the KM device.

In step (f), the user can control the keyboard to copy the file according to the place of the pointer. For example, pressing “Ctrl” and “V” simultaneously to deal with the copy operation. In step (h), the user can control the keyboard to paste the file according to the place of the pointer. For example, pressing “Ctrl” and “V” simultaneously to deal with the paste operation.

The present invention discloses a concept of using a KM device for transferring files between the associated computers. It is to benefit a user who is operating the KM device.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for transferring a file through a KM device between associated computers comprising the step of:
(a) coupling a first computer host connected to a first monitor, a second computer host connected to a second monitor, a keyboard and a pointing device to the KM device;
(b) initializing a pointer on the first monitor which is controlled by the pointing device; and
(c) moving a file displayed on the first monitor to the second monitor by the pointer controlled by the pointing device for transferring the file from the first computer host to the second computer host through the KM device.

2. A method for transferring a file through a KM device between associated computers according to claim 1, further comprising the step of: acquiring boundaries of the first monitor and the second monitor.

3. A method for transferring a file through a KM device between associated computers according to claim 1, wherein the step (c) comprising the steps of:
(c1) moving the pointer controlled by the pointing device on the file displayed on the first monitor;
(c2) pressing and holding a first button on the pointing device;
(c3) moving the pointer from the first computer host to the second computer host; and
(c4) releasing the first button for transferring the file from the first computer host to the second computer host through the KM device.

4. A method for transferring a file through a KM device between associated computers according to claim 1, wherein the step (c) comprising the steps of:
(c1) moving the pointer controlled by the pointing device on the file displayed on the first monitor;
(c2) pressing a second button on the pointing device;
(c3) moving the pointer from the first computer host to the second computer host; and
(c4) pressing the second button again for transferring the file from the first computer host to the second computer host through the KM device.

5. A method for transferring a file through a KM device between associated computers according to claim 4, wherein the second button in the step (c2) is functioned to copy the file.

6. A method for transferring a file through a KM device between associated computers according to claim 4, wherein the second button in the step (c4) is functioned to paste the file.

7. A method for transferring a file through a KM device between associated computers and the method comprises the step of:
(a) coupling a first computer host connected with a first monitor, a second computer host connected with a second monitor, a keyboard and a pointing device to a KM device;
(b) initializing a pointer controlled by the pointing device on the first monitor;
(c) copy a file displayed on the first monitor;
(d) moving the pointer from the first monitor to the second monitor by the pointing device; and
(e) paste the file on the second monitor through the KM device.

8. A method for transferring a file through a KM device between associated computers according to claim 7, wherein the step (c) is control by the keyboard.

9. A method for transferring a file through a KM device between associated computers according to claim 7, wherein the step (e) is control by the keyboard.
